(19) United States
(12) Patent Application Publication
(10) Pub. No.: US 2010/0166939 A1
(43) Pub. Date: Jul. 1, 2010

(54) MODIFIED POTATO FLAKES OR MODIFIED POTATO GRANULES, PROCESS FOR PREPARING THEM AND USES THEREOF

(76) Inventors: Martin Lotz, Emlichheim (DE); Johannes B. Borghuis, Hoogezand (NL); Frank Schaiper, Ibbeburen (DE); Christian Francke, Emstek (DE)

Correspondence Address: Arthur M Reginelli, 4 th Floor, First National Tower, Akron, OH, 44308, US

(21) Appl. No.: 12/597,819

(22) PCT Filed: Apr. 25, 2008
(86) PCT No.: PCT/DE08/00712

§ 371 Date: Dec. 28, 2009

(30) Foreign Application Priority Data
Apr. 27, 2007 (DE) 10 2007 019 996.3

(51) Int. Cl. A23L 1/308; A23L 1/2165

(52) U.S. Cl. 426/637; 426/457; 426/464; 426/648

(57) ABSTRACT

The present invention relates to a process for preparing modified potato flakes or modified potato granules, comprising the steps of: a) washing potatoes; b) removing the peel and any impurities where applicable; c) optionally cutting the potatoes up; d) optionally blanching the potatoes; e) optionally cooling the potatoes if step d) is performed; f) cooking the potatoes under steam; g) sieving or pulping the potatoes cooked under steam; h) optionally adding additives other than fibrous materials; and i) drying the pulp obtained, wherein, after step b) and before step i), fibrous materials are added in at least one further step and are mixed substantially homogeneously into a product of the process as present at the time when they are added; modified potato flakes or potato granules prepared in accordance with said process, and their use.

The present invention relates to a process for preparing modified potato flakes or modified potato granules, modified potato flakes or granules produced by the process, and their use.

Potato flakes are a form of dehydrated potato. One advantage of dehydration is that potatoes in this form can be made stable for storage, while their use for the production of processed potato products is hardly limited as a result. Potato flakes are used in foods, such as snacks, extruded and deep-fried potato products. Modified potato flakes are also known which are important from the point of view of nutritional physiology, since they are frequently enriched with roughage and prebiotic substances.

One slightly modified form of potato flakes is potato granules, which differ from potato flakes in the preparation process merely in that they are dried in fluidised bed and dispersion driers, whereas roller drying is used in the production of potato flakes. Potato flakes swell directly when water is added, whereas potato granules still contain undamaged grains of starch, so that swelling can only be achieved by boiling them. The present invention specifically relates to processes for preparing both modified potato flakes and modified potato granules.

Drying a dough or pulp made from potatoes on roller driers in order to produce potato flakes has been known since the beginning of the 20th century. Since then, the processes have been optimised. Essentially, in order to prepare potato flakes, the potatoes are first washed, peeled and further cleaned where necessary. The potatoes obtained in this way are then cut into small pieces and blanched, the potato slices being kept at a temperature of 70-75° C. for about 20 minutes. The blanching step causes the starch in the cells to gelatinise. After that, the potato slices are cooled, so that the cell walls are not damaged. The potato slices are subsequently cooked in steam until they reach such a degree of softness that it is possible to sieve or pulp them with little damage to the cells. After that, additives are put in which improve the durability of the dried end product.

The product is finally delivered to a roller drier and dried there. A detailed description of the potato flake production process can be found in Willard, M. J., Hix, V. M. and Kluge, G., Dehydrated Mashed Potatoes—Potato Flakes. In: Potato Processing, 4th edition, Talburt, W. F. and Smith, O. eds. New York: Nostrand Reinhold, 1987, pages 557-612.

In order to increase the amount of roughage in potato flakes, it is still customary even today to omit the step of peeling the potatoes in the process described above, so that the whole potato is delivered to the process, including the skin, so that the flakes contain the whole potatoes. Standard ingredients added to potato flakes are intended to facilitate the further processing by being added to the pulp even at this stage, so that they can be blended in homogeneously. This saves the effort of adding such ingredients in the final processing stage. Such ingredients comprise spices, fats and emulsifiers, for example.

The process known in the state of the art does, however, entail a number of disadvantages. There is, for example, no step of sorting the potato qualities ideally. Green and damaged potatoes enter the process, and the quality and colour of the end product are unfavourable. One major disadvantage consists in the fact that glycoalkaloids, which are naturally present in the potatoes and cannot be destroyed by thermal treatment, have to be removed mechanically together with the skin material and the outer layers of the tuber, so that at least part of them remain in the potato flakes produced. As a result, an impairment to the health of sensitive individuals cannot be ruled out. Also, hygiene requirements according to modern standards are no longer satisfied by the known process. A further disadvantageous aspect is that the potato skins consist of lignin, which does not actually constitute roughage for the human body, since lignin is a wood-like substance. Roughage substances in the sense of nutritional physiological include indigestible natural polymers, whose bases usually consist of various sugars or carbohydrate derivatives, but may also consist of other basic units. Well-known examples of vegetable origin are cellulose, hemicelluloses, pectins, lignin, but also other natural polymers, such as inulin, a fructose polymer which is classified as a dietetic fibre because it is only metabolised in the large intestine.

Process additives used in the known process, both for the flake and granule production process and for the manufacture of the end products, are without exception not of potato origin and thus distort the natural character of the potato flakes and the end products made from them.

It is one object of the present invention to provide a process of preparing modified potato flakes or granules with which the disadvantages of the state of the art can be overcome. In particular, the intention is to provide a process which results in an enhanced product quality, which not only achieves an accumulation of roughage in the nutritional physiological sense, but also improves the characteristics when processing the potato flakes or granules into desired end products.

The object is also to provide novel modified potato flakes or potato granules and to indicate possible uses for them.

The objects are achieved by a process for preparing modified potato flakes or modified potato granules in accordance with claim 1, modified potato flakes or potato granules in accordance with claim 15 and possible uses in accordance with claim 22. Preferred embodiments can be seen from the various dependent claims.

It has surprisingly been found that the modified potato flakes or potato granules produced in accordance with the process of the invention not only possess a higher roughage content, but are also considerably improved with regard to their technical processing characteristics. Some of the advantages concerning processing technology are, among others, an increase in cold viscosity, the formation of a peak in the hot viscosity and an improvement in the water binding ability. A product can therefore be prepared which exhibits a quicker development of hot viscosity. This is an important basic parameter in the snack industry, for example.

Similarly, it is possible with the process of the invention to compensate for fluctuations connected with the different varieties, the harvest or the seasons and to produce potato flake or granule products which are standardised to an extent and degree that was hitherto not possible.

The modified potato flakes or granules of the invention may have a large number of fibrous materials added to them. Suitable fibrous materials can be selected from vegetable or non-vegetable fibrous materials in order to exert a positive effect on such properties as roughage content (prebiotic, positive effect on health), characteristics regarding application technology, such as water binding or lipophobia. Fibrous materials may, for example, be selected from potatoes, legumes, such as peas, beans, lupins, sugar cane, sugar beet, bamboo, bran from various cereals, such as wheat, rye, barley, oats, maize, triticale, rice, or their pure fibres, citrus fruits, such as lemons, oranges and limes, and other types of fruit and vegetable, such as apples, pears and carrots. Fibres of non-vegetable origin can also achieve the above-mentioned advantages of the invention. Examples mentioned are natural polymers of alginate (obtained from marine algae) and carrageenan. Fibres produced separately in a prior production process, such as pure cellulose, carboxymethylated cellulose (CMC), microcrystalline cellulose (MCC), gum arabic and mixtures of all the fibrous materials mentioned can also be used.

It is particularly preferred in this context to add potato fibres, since in this way the advantageous healthy inherent nature of the potato product is maintained. The use of potato fibres has the further advantage that they do not have to be declared according to the law relating to food and drugs and are not foreign either in the scientific sense or from the point of view of nutritional physiology.

In one particularly preferred embodiment, the drying in step i) in the process of the invention can be optimised by means of prior mixing with fibrous materials which have already been dried previously.

According to the invention, it may likewise be provided as an alternative or in addition that the mixing described above is not limited to mixing with fibrous materials. On the contrary, it is quite generally possible that a dried end product which has already been prepared is added in a certain proportionate amount after step b) and before step i). The proportion of the added, dried end product in the process of the invention can readily be adjusted by a person skilled in the art on the basis of the intended use. Similarly, the proportion of the dried end product after step i) which is supposed to be returned to the process can easily be determined by a person skilled in the art bearing in mind an optimum process run. It is particularly preferred to return a proportion of a dried end product in the production of modified potato granules, but this can likewise be done in the production of modified potato flakes.

One reason among others for returning product that has already been dried may be to facilitate the drying per se. It is, for example, possible to add so much product that has already been dried that the subsequent drying in step i) can be carried out in a single drying step and it is not indispensable to dry more than once (as in the case of fluidised bed or dispersion driers, for example) or to increase the drying time (in the case of roller driers, for example, such as by providing a longer dwell time on the roller, e.g. by having it rotate more slowly or by increasing the steam temperature for drying), which may have an extremely negative influence on the functional and nutritional physiological properties of the dried potato product. Especially by adding dried fibres, drying step i) can be kept to a minimum, which simplifies the process engineering and reduces the manufacturing costs.

The content of reducing sugars is likewise essential for the product quality of modified potato flakes and granules, since they lead to the formation of acrylamide in the flakes, the content of which can be further increased many times in heated products. During the heating process in the course of manufacturing, reducing sugars give the finished products, such as stackable chips made from potato flakes, an undesirable pronounced brown colouring. Since the fibres do not contain any reducing sugars, they proportionately reduce their content (acrylamide and brown colour) in the modified potato flakes and granules of the invention and the finished products made from them.

In the following, a detailed description of one embodiment of the process in accordance with the invention is provided, on the basis of adding potato fibres as fibrous materials. A person skilled in the art concerned will readily appreciate that potato fibres can with no difficulty be replaced by other fibrous materials that appear obvious to the skilled person. The following detailed description is provided with reference to the drawings, in which

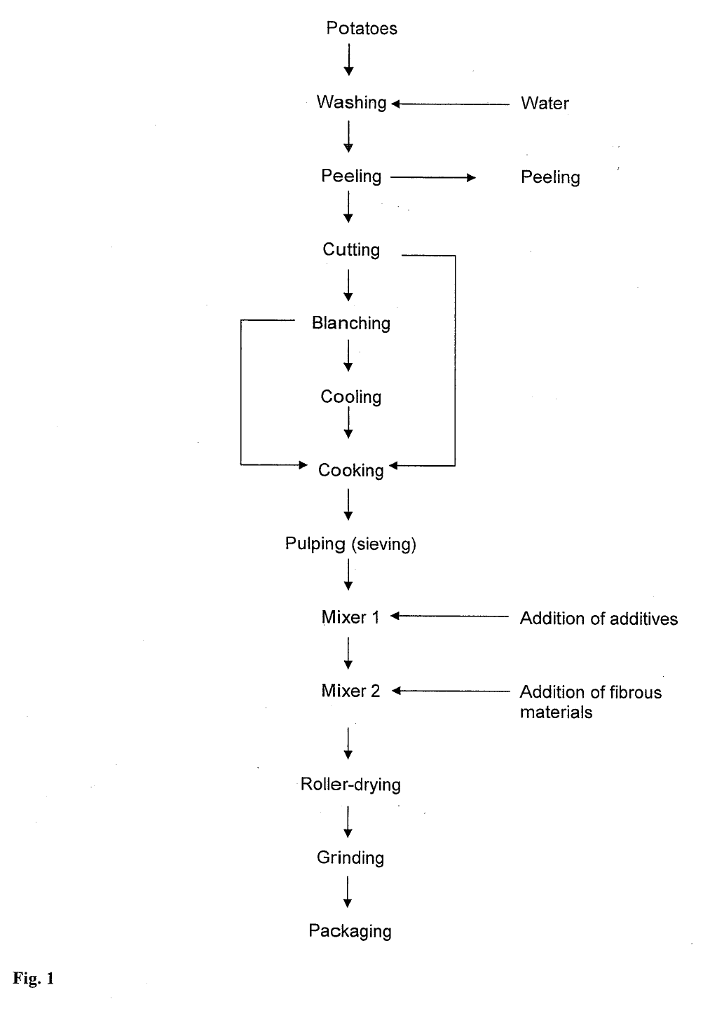

FIG. 1 shows a flow chart for a preferred embodiment of the process of the invention;

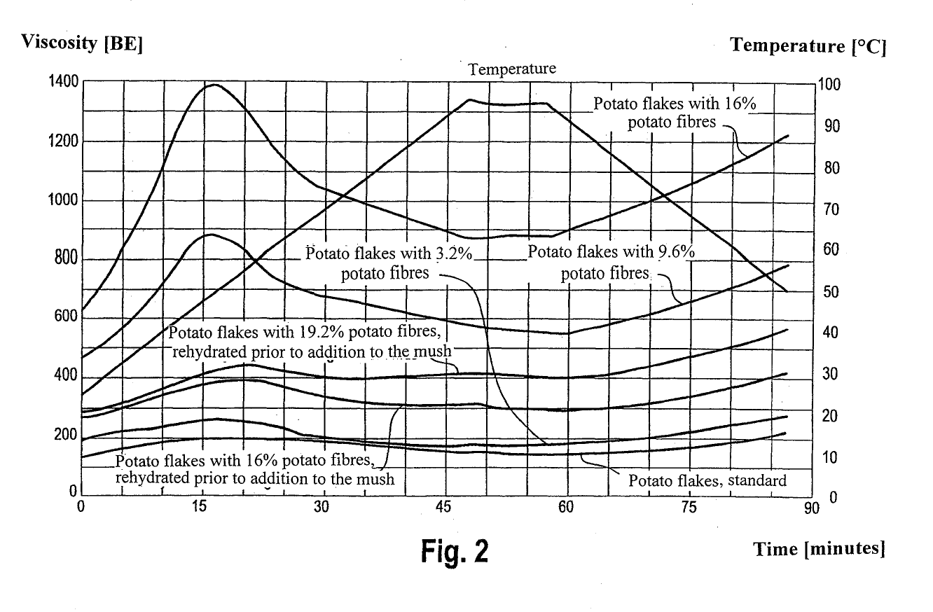

FIG. 2 shows a graph in which values for the hot viscosity of potato flakes with different contents of potato fibres are plotted against time; and

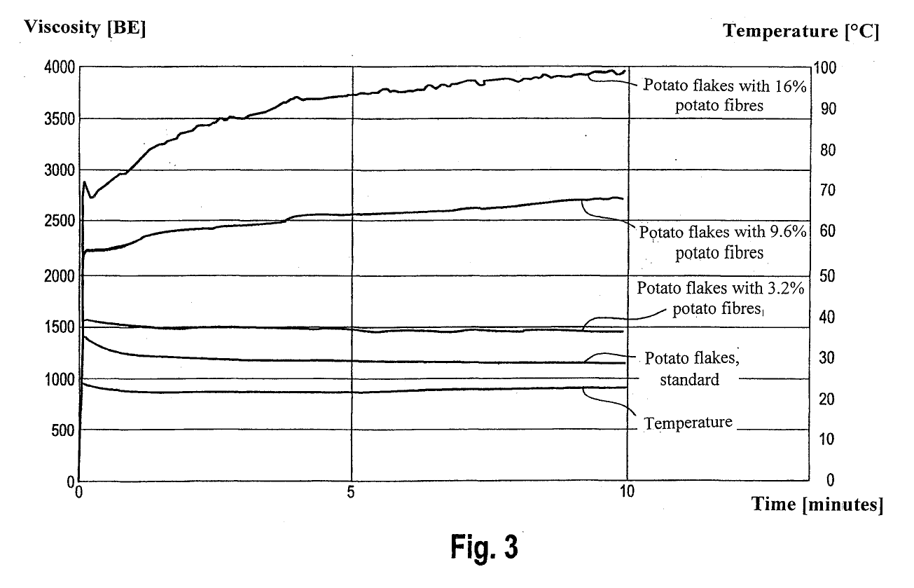

FIG. 3 shows a graph in which values for the cold viscosity of potato flakes with different contents of potato fibres are plotted against time.

In the process of the invention, potatoes are first washed thoroughly, after which the peel of the potatoes can be removed to the desired extent—substantially completely or only partially—by steam, lye or brush peelers, for example. At this stage, any green potatoes, shoots and stones present are also removed, which must be regarded as impurities. The peeled and cleaned, sorted potatoes are now cut into thick slices about 1 cm in diameter, which ensures a uniform transfer of energy during the subsequent blanching and cooling steps. In principle, the blanching step, which can be carried out at 70 to 75° C. for about 20 minutes, is optional and can be omitted, as can the cooling step, in which case one speaks of a “low-leach process”, since less starch is washed out. During blanching, the grains of starch gelatinise and retrograde again during the subsequent cooling step, which is carried out at a temperature of less than 24° C. and lasts for about 20 minutes. Thanks to the retrograding, the product and the doughs made from it are less sticky, which makes further processing easier.

Following the cooling step, the product is cooked under steam so that the potato pieces can subsequently be sieved into a pulp. The cooking time varies considerably, depending to a great extent on the starch content of the potatoes. The potato pieces can be sieved or reduced to pulp with rotating perforated cylinders, for example. In a subsequent step, additives may be added with the intention, for example, of improving the ease of processing; such additives may be emulsifiers, or also fat, preservatives, flavourings and spices. The final drying step is advantageously performed on roller driers, the pulp being distributed evenly on the drying roller with the aid of, for example, 4 to 6 applicator rolls. At the same time, any defects are removed from the paste pulp, since they adhere there and are scraped off. The pulp is dried in the form of a thin film, scraped off by a blade over the entire length of the roller and can then be ground, for example, and finally packed.

In order to produce potato granules, the final drying step may be performed in fluidised bed and dispersion driers instead of on rollers. The flakes or granules produced in accordance with the invention do not differ in any way as far as their advantageous properties are concerned, but merely constitute a different form of the modified potato products of the invention.

In contrast to the process known from the state of the art, the process of the invention for preparing modified potato flakes or granules involves an additional step, in which fibrous materials are added and mixed substantially homogeneously with the product of the process as present at the time when they are added. In particular, fibrous materials with defined properties and compositions can be added, and in this way the fibre content in the product can be adjusted at will. There is no longer any limitation to peel components as the fibre content. This means that there are no longer any limits on the quantity, and products with a higher fibre content can be generated.

The addition of fibrous materials, especially potato fibres, can take place at any step in the process as desired, between peeling (step b)) and drying (step i)) the potatoes. Nevertheless, it makes most sense to do so during the process step during which the least effort is required to blend the potato and fibre pulp homogeneously. The preferred addition point is after sieving or pulping, when the potatoes, which have already been peeled, sliced, blanched, cooled and boiled, have become a paste-like potato pulp, into which the potato fibres can be added and incorporated homogeneously with a simple mixing apparatus. This can be done in one step together with the other standard additives or before or after the standard additives have been added.

The form in which the potato fibres may be present can vary considerably. First of all, natural, non-dried fibres can be added, with their moisture content resulting from the production process. A further possibility is first to dry the potato fibres, as a result of which they have a good storage life. They can be added in this dry state to the potato pulp which is to be dried into potato flakes or, by first placing the potato fibres back in water, preferably in a water-fibre ratio that corresponds to the natural state before the fibres are dried, added to the potato flake pulp in moist form. It is also possible to use combinations of moist, dried and re-hydrated fibres. If dry potato fibres are used, the subsequent drying step can be optimised. It should be pointed out once again that not only potato fibres can be used, of course, but any fibrous materials in whatever dry, moist and/or rehydrated form appears appropriate to the person skilled in the art for the purposes of the invention.

When dry fibres are added, the water content in the potato/fibre pulp which has to be evaporated when drying is reduced in accordance with the dry solids content of the fibres and the mixing ratio of potato pulp and fibres, which lowers the drying costs and the amount of energy required. It has surprisingly been found that, in addition, the drying capacity increases disproportionately when a roller drier is used compared to the increase in the dry solids content as a result of adding dry fibres, which also makes a contribution to environmental protection because of the lower specific energy consumption.

With the process of the invention, it is possible to control, in a targeted manner, the content of reducing sugars, the roughage content, the peak and the gradient of the hot viscosity, the gradient and level of the cold viscosity, the water binding ability, the acrylamide content in heated, especially deep-fried, end products, the amount of fat absorbed during deep-frying, etc. The dry fibres may be added, for example, by means of a semi-rotary gear pump which makes it possible to control the amount precisely. In principle, however, any other conveyor means which is suitable for metering powder can be used in combination with a rate control. After the vegetable fibres are added, there is preferably a mixing step. This may, for example, be a mixing distance of approximately 1 to 10 m, preferably 8-10 m in length, e.g. in the form of a screw mixer, on which the added fibres blend with the potato pulp and the water content is evened out between the components, or it may also be an active mixing unit, such as a paddle mixer. After an appropriate dwell time for blending, the mixture can then be delivered to a roller drier and dried, where the capacity (yield/h) increases, even though the mixer speed is reduced. Thanks to this process step, the water binding ability and the formation of the hot viscosity improve.

Fibres in an aqueous, pasty consistency can likewise be added simply and precisely. Suitable apparatuses for this purpose are eccentric screw pumps, though any other forced conveyor means can also be used.

The enhanced water binding ability of the modified potato flakes and granules of the invention make it possible for the end product to retain a juicier texture for a longer period of time. At the same time, the lipophobic structure of the dough prevents too much fat from penetrating the product during deep-frying, so that it has a lower fat content.

The potato flakes of the invention can have a roughage content of about 22.6 to about 24.2% by weight, based on the total weight of the potato flakes, with a potato fibre content of about 10% (measured as Total Dietary Fibre, TDF, according to AOAC 991,43), compared to a roughage content of 7.0% by weight in potato flakes with no added fibre, which obviously means a substantial improvement in the nutritional value of the potato flakes produced in accordance with the invention.

The following examples further illustrate the advantages of the subject matter of the present invention, without being limited to the embodiments disclosed there.

### EXAMPLE 1

### Capacity Increase

### Dry Fibres and Rehydrated Fibres

Potato fibres are blended with the potato pulp obtained in the process according to the present invention after step g). Since these added potato fibres have a dry solids content (DS) of 90 to 95%, they proportionately reduce the amount of water to be evaporated on a roller drier, which considerably increases its production capacity. It has surprisingly been found that the capacity increase is disproportionate, which saves energy and thus reduces the manufacturing costs and the burden on the environment. Results for the capacity increase using a roller drier for potato pulp products with different fibre contents are shown in Table 1.

TABLE 1

| | | | | | |
|---|---|---|---|---|---|
| Proportion of fibres (% by weight) | 0 | 3.2 | 9.6 | 16.0 | 19.2 |
| Water reduction in the pulp/fibre | 0 | 2.3 | 6.6 | 10.3 | 12.1 |
| blend (% by weight) | | | | | |
| Capacity (kg/h) | 9.43 | 9.80 | 10.43 | 11.37 | 10.93 |
| Capacity increase (% by weight) | 0 | 3.9 | 10.6 | 20.6 | 15.9 |
| Disproportionate capacity increase | 0 | 1.3 | 4.0 | 10.3 | 3.8 |
| (% by weight) | | | | | |
| Relative capacity increase (%) | 0 | 33.3 | 37.7 | 50.0 | 23.9 |

### EXAMPLE 2

### Hot Viscosity

The hot viscosity evaluates the reconstruction behaviour, the swelling capacity and the influence of temperature on the product viscosity. It is expressed in Brabender units (BU).

455 g water and 45 g sample are mixed for 20 seconds with a hand mixer on level 2. The mixture is then placed in a measuring bowl, a Brabender Viscograph E viscometer being used as the measuring device. The apparatus setting is as follows:

| | | |
|---|---|---|
| Measuring range: | 700 | cmg |
| Initial temperature: | 25° | C. |
| Heating rate: | 1.5° | C. |
| Maximum temperature: | 95° | C. |
| Holding time: | 10 | min |
| Cooling phase: | to 50° | C. |
| Cooling rate: | 1.5° | C./min |

In FIG. 2, the hot viscosities for native potato flakes and some modified potato flakes of the invention can be seen. The figures for the fibre content are based on the percentage by weight of the dry weight.

### EXAMPLE 3

### Cold Viscosity

The cold viscosity evaluates the ability to form a viscoelastic network. The cold viscosity is likewise expressed in Brabender units (BU). It is measured over a period of 10 minutes at a constant temperature of 20° C.

For this purpose, 350 g water and 50 g sample are mixed for 20 seconds with a hand mixer on level 2. The mixture is then placed in a measuring bowl, a Brabender Viscograph E viscometer being used as the measuring device. The apparatus setting is as follows:

| | | |
|---|---|---|
| Measuring range: | 700 | cmg |
| Initial temperature: | 20° | C. |
| Measuring rate: | 10 | min |

FIG. 3 shows the cold viscosities for native potato flakes and some modified potato flakes of the invention. The figures for the fibre content are based on the percentage by weight of the dry weight.

### EXAMPLE 4

### Reducing Sugars

The content of reducing sugars is the limiting parameter for the use of flakes for the production of stackable chips. Under no circumstances must it exceed 3% by weight, since the products otherwise take on too pronounced a brown colour. The use of wet fibres in flakes according to the process of the invention reduces the content of reducing sugars, as can be seen from the following Table 2.

TABLE 2

Content of wet fibres
in potato flakes (% DS)

| | 0 | 12 | 21 | 30 |
|---|---|---|---|---|
| Content of reducing | 0.07 | 0.06 | 0.045 | 0.04 |
| sugars (% glucose) | | | | |

### EXAMPLE 5

### Acrylamide

The low content of acrylamide in modified potato flakes produced in accordance with the invention and in stackable chips made from them is shown in Table 3 compared to conventional potato flakes and stackable chips made from them. Since the detection threshold for acrylamide in potato flakes is 40 μg/kg, but the real content is lower, no statement can be made about the actual content. What is decisive for the benefit and the health of the consumer, however, is the acrylamide content in the end products produced from the potato flakes, e.g. stackable chips. Here, there is an impressive correlation between the reduction in the acrylamide content and the increased addition of potato fibres.

TABLE 3

| | Acrylamide |
|---|---|
| Product | content (μg/kg) |
| Potato flakes without fibres | <40 |
| Potato flakes with 10% fibres | <40 |
| Potato flakes with 16% fibres | <40 |
| Stackable chips made from normal potato flakes | 131 |
| Stackable chips made from potato flakes with 10% fibres | 56 |
| Stackable chips made from potato flakes with 16% fibres | <4 |

### EXAMPLE 6

### Production of Potato Chips

Thanks to the use of potato flakes produced in accordance with the invention, the nutrient density in products is reduced and/or the fat absorption is reduced. Similarly, products with novel textures are possible. This is described taking the production of potato chips using the modified potato flakes as an example, compared to a basic recipe with conventional potato flakes:

| | | Recipe with potato flakes | |
|---|---|---|---|
| Basic recipe | | with 9.6% potato fibres | |
| Potato flakes standard | 26% | Potato flakes 9.6% fibres | 23% |
| Potato starch | 13% | Potato starch | 30% |
| Monosodium glutamate | 2% | Monosodium glutamate | 3% |
| Salt | 1% | Salt | 2% |
| Water, ice-cooled | 58% | Water, ice-cooled | 42% |

The ingredients are mixed with dough hooks in a stirring pan. After that, water is mixed in and kneading continues for 10 minutes. Next, the dough is rolled out to a thickness of 0.35 mm. Blanks of dough 60 mm in diameter are cut out and deep-fried for 35 to 50 seconds at 180° C. The colour values of the chips produced with the potato flakes prepared in accordance with the invention were noticeably more pleasant than in the basic recipe, i.e. the colour remained yellowish-orange compared to an orange-brown for potato chips, prepared according to the basic recipe.

The features of the invention disclosed in the above description, in the claims and in the drawings can be essential to implementing the invention in its various embodiments both individually and in any combination.

1. A process for preparing modified potato flakes or modified potato granules, comprising the steps of:
a) washing potatoes;
b) removing the peel and any impurities where applicable;
c) optionally cutting the potatoes up;
d) optionally blanching the potatoes;
e) optionally cooling the potatoes if step d) is performed;
f) cooking the potatoes under steam;
g) sieving or pulping the potatoes cooked under steam;
h) optionally adding additives other than fibrous materials; and
i) drying the pulp obtained,
characterised in that, after step b) and before step i), fibrous materials are added in at least one further step and are mixed substantially homogeneously into a product of the process as present at the time when they are added.

2. The process as claimed in claim 1, characterised in that the peel is removed using steam, lye and/or brush peelers in step b).

3. The process as claimed in claim 1, characterised in that in step c), the potatoes are cut into slices about 1 cm thick.

4. The process as claimed in claim 1, characterised in that the blanching in step d) takes place at 70-75° C. for about 20 minutes.

5. The process as claimed in claim 1, characterised in that, in step e), the cooling is to a temperature of less than 24° C., and the cooling preferably lasts for about 20 minutes.

6. The process as claimed in claim 1, characterised in that the potatoes are sieved or reduced to pulp in step g) by means of rotating perforated cylinders.

7. The process as claimed in claim 1, characterised in that step i) is performed by means of roller drying and/or drying with fluidised bed and dispersion driers.

8. The process as claimed in claim 1, characterised in that the fibrous materials are added dried and/or as a pulp, optionally in separate steps.

9. The process as claimed in claim 8, characterised in that dry fibrous materials are added by means of a semi-rotary gear pump and/or a paddle mixer.

10. The process as claimed in claim 8, characterised in that fibrous materials are added by means of forced conveyor means, preferably an eccentric screw pump.

11. The process as claimed in claim 8, characterised in that the pulp of fibrous materials has a water content of 10 to 90% by weight, based on the total weight of the pulp.

12. The process as claimed in claim 1, characterised in that the fibrous materials are added after step g).

13. The process as claimed in claim 12, characterised in that the fibrous materials are mixed into the product of the process by means of screw mixers and/or paddle mixers.

14. Modified potato flakes or modified potato granules, obtainable according to a process in accordance with claim 13.

15. The modified potato flakes or modified potato granules as claimed in claim 14, characterised in that the fibrous materials comprise vegetable and/or non-vegetable fibrous materials.

16. The modified potato flakes or modified potato granules as claimed in claim 15, characterised in that the fibrous materials are selected from the group of fibrous materials consisting of potatoes, legumes, especially peas, beans, lupins, sugar cane, sugar beet, bamboo, bran from various cereals, such as wheat, rye, barley, oats, maize, triticale, rice, pure cereal fibers, citrus fruits, especially lemons, oranges, limes, apples, pears, carrots, alginate, carrageenan, cellulose, carboxymethylated cellulose, microcrystalline cellulose, gum arabic and mixtures thereof.

17. The modified potato flakes or modified potato granules as claimed in claim 16, characterised in that the fibrous materials are potato fibres.

18. The modified potato flakes or modified potato granules as claimed in claim 15, characerised in that the fibrous materials are present in an amount of less than 50% by weight, preferably less than 25% by weight, particularly preferably 5 to 20% by weight, based on the total weight of the modified potato fibres.

19. The modified potato flakes or modified potato granules as claimed in claim 15, characterised in that they further contain additives.

20. The modified potato flakes or modified potato granules as claimed in claim 19, characterised in that the additives are selected from emulsifiers, preservatives, fats, spices, flavourings and mixtures thereof.

21. The use of modified potato fibres or modified potato granules as claimed in claim 1 in foodstuffs.

22. The use as claimed in claim 21 in directly or indirectly expanded snacks, nibbles, cakes and pastries, deep-fried potato products, creamed potatoes, deep-frozen products, meat and sausage products and functional foods.
